(19) United States
(12) Patent Application Publication
(10) Pub. No.: US 2018/0242759 A1
(43) Pub. Date: Aug. 30, 2018

(54) PROCESS FOR THE PRODUCTION OF DISPLAYS FROM ALVEOLAR OR CELL PLATES OF THERMOPLASTIC POLYMERS AND/OR COPOLYMERS

(71) Applicant: ARQUIFOAM IP, LLC, West Los Angeles, CA (US)

(72) Inventors: Ricardo Jorge Keuroglian Saghatian, Montevideo (UY); José Santiago Geozucaraian Bardakchian, Montevideo (UY)

(73) Assignee: ARQUIFOAM IP, LLC, West Los Angeles, CA (US)

(21) Appl. No.: 15/758,239

(22) PCT Filed: Sep. 6, 2016
(86) PCT No.: PCT/US16/50386

§ 371 Date: Mar. 7, 2018

(30) Foreign Application Priority Data
Sep. 7, 2015 (AR) P2015 01 02855

(51) Int. Cl. A47F 5/10; B26D 5/00; B26D 3/14; B26F 1/44; B23K 26/38; B23C 3/28

(52) U.S. Cl. CPC A47F 5/10; B26D 5/005; B23C 3/28; B26F 1/44; B23K 26/38; B26D 3/14

(57) ABSTRACT

A process to produce displays from alveolar or cell plates of synthetic of thermoplastic synthetic polymers and/or copolymers is provided. The process may include: a) arranging an alveolar or cell plate on a table of a cutting device; b) establishing reference points; c) recognizing the positions of the reference points taking their location as correlation; d) performing a plurality of carvings on the plate taking the reference points into account, where the carvings are defined by the design of the display to be manufactured, and wherein said carvings are executed according to steps disclosed herein, where the resulting cuts, slits and recesses allow separating portions, to fold by forming closed or open corners, insert portions without locking, insert portions by locking with swinging fins, and combinations thereof; and e) assembling the display to result in a self-supporting structure of a display.

### FIELD OF THE INVENTION

The present invention belongs to the field of methods for forming useful structures as displays of goods and the displays thus obtained, in particular it refers to those processes applied to displays that are formed from plates of plastic materials, more in particular those plates which can be formed by cutting, fretwork, holes, etc. and which have enough flexibility to assemble the displays on the one hand and the required rigidity to serve the effect.

### BACKGROUND OF THE INVENTION

It is a normal issue that the goods are exposed to the eyes of the consumers so that they can evaluate before they decide to purchase.

Therefore, for the marketing of countless articles, especially those of mass retail, displays are used, where the available items are exposed.

In addition, items can be ordered in displays and sort by different patterns chosen depending on the type of merchandise and according to the needs and the views of the merchandiser.

It is so that well known shelves of different type are mounted on the walls of the shops and even furniture that is made of different materials, which have been used for a long time particularly in retail outlets.

It is common in outlets stores such as supermarkets, shops, pharmacies, etc., the outstanding exhibition of consumer products in and out of the shelves. For this, displays that enhance and promote the sale thereof are used.

Traditionally, different materials have been used for making them, we can mention: wood, wire, pipe, metals, thermoforming, plastic, injections and/or a combination of any of them.

The difficulty in the current use of these materials is their cost, their high processing time and the excessive cost logistics and storage, given that they are usually delivered assembled.

Therefore, a new class of displays is proposed, which consists of polymeric plastic materials, preferably sheets of corrugated plastic material, also known as alveolar plastic sheeting or plastic plates with flutes, which are plates with a structure consisting of two outer sheets separated by a series of parallel walls.

Such alveolar plates are composed of polymers and/or thermoplastic synthetic copolymers such as polyethylene, polypropylene and polyvinyl chloride, among the highlights.

These displays are lighter but at the same time they are weather resistant, and inexpensive, which facilitates mobility in order to change the structure and design according to the articles to be marketed, suitable as required, ultimately suitable and custom structures are required, designed for certain products at an affordable cost that can be easily absorbed by the merchandiser or provider.

### SUMMARY OF THE INVENTION

The present invention thus relates to a process to produce displays from alveolar or cell plates of thermoplastic synthetic polymers and/or copolymers, said process comprising the stages of:

a) arranging an alveolar or cell plate on a table of a cutting device;

b) establishing reference points;

c) recognizing the positions of the reference points taking their location as correlation;

d) performing a plurality of carvings on the plate taking the reference points into account, where the carvings are defined by the design of the display to be manufactured, and wherein said carvings are executed according to the following steps selected from:
i) cutting completely through the plate;
ii) cutting partially on the surface avoiding piercing the plate completely;
iii) slitting V-shaped notches avoiding piercing the plate completely and the slit being in a parallel direction to the internal channels of the plate;
iv) slitting V-shaped notches avoiding piercing the plate completely and the slit being in a perpendicular direction to the internal channels of the plate;
v) slitting U-shaped fretworks avoiding piercing the plate completely;
vi) partially reduce the thickness of the plate to obtain U-shaped fretworks; and
vii) combinations of two or more of the above i) to vi);
where the cuts, slits and recesses allow separating portions, to fold by forming closed or open corners, insert portions without locking, insert portions by locking with swinging fins, and combinations thereof; and

e) assembling the display by folding, inserting and locking its constituent parts, where the cuts, slits and recesses executed according to the steps i) to vii) of the previous stage d) allow separating parts, to fold by forming closed or open corners, and insert parts without locking and insert parts by locking with swinging fins, so that a self-supporting structure of a display is obtained according to a predetermined design.

Additionally, prior to stage e) of assembling the display, a stage of packing, distributing and delivering the display as a flat carved plate at its installation or use site is performed.

Preferably, prior to stage e) of assembling the display by folding, inserting and locking its constituent parts, a film having printed the main graphic design of the display is applied.

Alternatively, before the additional stage of packing, distributing and delivering the display as a flat carved plate at its installation or use site a film having printed the main graphic design of the display is applied.

Preferably, the film is a self-adhesive vinyl.

Optionally, prior to stage a) of arranging an alveolar or cell plate on a table of a cutting device, the process comprises the additional stages of:

a′) printing a main graphic design of the display on a face of the alveolar or cell plate together with a plurality of registration marks that serve as a position register reference, wherein these registration marks are printed in any color different from the color of the substrate and on the face of the plate where the main graphic design of the display is located; and

a″) making through holes matching the printed registration marks in the previous step a′).

Consequently, stage a) of arranging the alveolar or cell plate on the table of the cutting device consists of a′″) arranging the alveolar or cell plate on the table of the cutting device so that the face where the main design of the display and the registration marks were printed is facing down.

Then, after stage a) of arranging the alveolar or cell plate on the table of a cutting device with the printed side facing down, stages b) and c) respectively consist of:

b′) setting reference points based on the through holes of the registration marks; and

c′) recognizing the positions of the reference points based on the through holes of the registration marks taking their location as correlation.

Preferably, the registration marks of stage a′) are points, crosses, lines, circles, squares, or the like.

More preferably, the through holes of step a″) are performed by any manual, semiautomatic or automatic method.

Also preferably, the constituent materials of the alveolar or cell plates are thermoplastic synthetic polymers and/or copolymers selected from polyethylene, polypropylene and polyvinyl chloride.

Particularly, the cutting device is a cutting device by Computer Numerical Control (CNC) comprising: a flat table with a head with interchangeable tools that are selected from cutter, laser, milling cutter, V-shaped cutting blade (V-Notch) and combinations thereof.

Preferably, in step d) i) cuts are performed by a blade or laser which define and allow separating the different parts of the plate display.

Also preferably, in step d) ii) cuts are performed by a blade or partly laser surface to avoid cutting completely through the plate, allowing the display parts not to separate and to remain linked to each other so that they can function as a hinge during the display assembly.

Additionally and preferably, by combining step d) i) of cutting completely through the plate to generate a fretwork and step d) ii) of cutting partially on the surface of the plate to generate a plate portion as a hinge, an insert with linked insurance is obtained.

Further preferably, in step d) iii) or step d) iv) V-shaped notches are performed by means of a blade with slanted edges at 45° to avoid cutting completely through the plate and allowing a folding of the plate by angular cutting during the display assembly.

In another even preferred form, in step d) v) U-shaped fretworks are performed by a milling cutter to avoid cutting completely through the plate and allowing a folding of the plate by fretwork during the display assembly.

In yet another preferred form, in step d) vi) U-shaped fretworks are performed by a milling cutter, said fretworks being partial recesses of the thickness of the plate to allow a non-through insert during the display assembly.

In still yet another preferred form, step d) v) of slitting or step d) vi) of reducing using a milling cutter is for generating folds areas.

### BRIEF DESCRIPTION OF THE FIGURES

FIG. 1 shows a schematic detail of a section of an alveolar or cell plate of polypropylene and/or polypropylene copolymers according to step d) i) of a preferred embodiment of the procedure to produce displays according to the present invention, wherein the cutting is performed by a blade piercing the plate completely.

FIG. 2 shows a schematic detail of a section of an alveolar or cell plate of polypropylene and/or polypropylene copolymers according to step d) ii) of a preferred embodiment of the procedure to produce displays according to the present invention, wherein the cutting is partially performed by a blade on the surface to avoid cutting completely through the plate.

FIG. 3A shows a schematic detail of a V-shaped notch of an alveolar or cell plate of polypropylene and/or polypropylene copolymers according to step d) iii) of a preferred embodiment of the procedure to produce displays according to the present invention, wherein the notch is effected by means of a blade with slanted edges at 45° to avoid cutting completely through the plate and the slit being in a parallel direction to the internal channels of the plate.

FIG. 3B shows a schematic detail of a V-shaped notch of an alveolar or cell plate of polypropylene and/or polypropylene copolymers according to step d) iv) of a preferred embodiment of the procedure to produce displays according to the present invention, wherein the notch is effected by means of a blade with slanted edges at 45° to avoid cutting completely through the plate and the slit being in a perpendicular direction to the internal channels of the plate.

FIG. 4 shows a schematic detail of a U-shaped fretwork of an alveolar or cell plate of polypropylene and/or polypropylene copolymers according to step d) v) of a preferred embodiment of the procedure to produce displays according to the present invention, where the fretwork is effected by a milling cutter to avoid cutting completely through the plate.

FIG. 5 shows a schematic detail of a U-shaped fretwork of an alveolar or cell plate of polypropylene and/or polypropylene copolymers according to step d) vi) of a preferred embodiment of the procedure to produce displays according to the present invention, where the fretwork is effected by a milling cutter which partially reduces the thickness of the plate.

FIG. 6 shows a particular structural design of a self-supporting display obtained by a preferred embodiment of the procedure according to the present invention once assembled, where a detail A is indicated in a folding thereof.

FIG. 7 shows detail A of FIG. 6 extended where a folding of the alveolar or cell plate of polypropylene and/or polypropylene copolymers of the display is shown, where a longitudinal scan was performed according to the internal channels of the plate (may also be cross-sectioned due to design conditions or limitations on the available area of the plate) by a milling cutter according to step d) v) of a preferred embodiment of the procedure according to the present invention.

FIG. 8 shows an exploded view of the display of FIG. 6 obtained by a preferred embodiment of the procedure according to the present invention.

FIG. 9A shows a partial view of a display obtained by a preferred embodiment of the procedure according to the present invention during the first assembling step of one of its inserts comprising an assembly insurance. In this step, the pieces to be inserted are opposed.

FIG. 9 B shows a partial view of the display of FIG. 9 A during the second assembling step of one of its inserts comprising an assembly insurance. In this step, a security fin pivots out prior to effecting the insert of the opposing pieces.

FIG. 9 C shows a partial view of the display of FIG. 9 A during the third assembling step of one of its inserts comprising an assembly insurance. In this step, one of the opposing pieces is inserted into the existing insert fretwork in the other piece by applying a horizontal forward movement, while the security fin is pivoted outward.

FIG. 9 D shows a partial view of the display of FIG. 9 A during the fourth assembling step of one of its inserts comprising an assembly insurance. In this step, the inserted piece within the existing insert fretwork in the other piece is moved downward by applying a vertical forward movement so that the fretwork of the inserted piece fits into the thickness of the wall of the fretwork of the other piece while the security fin is pivoted outward.

FIG. 9 E shows a partial view of the display of FIG. 9 A during the fifth assembling step of one of its inserts comprising an assembly insurance. In this step, the security fin that was pivoted outward is pushed to its initial position by locking and preventing upward movement of the inserted piece within the insert.

FIG. 9 F shows a partial view of the display of FIG. 9 A during the sixth assembling step of one of its inserts comprising an assembly insurance. In this last step, the completed insert is observed, with the security fin is in position to prevent the upward movement of the inserted piece within the insert.

### DETAILED DESCRIPTION OF THE INVENTION

The present invention relates to a process to produce displays from alveolar or cell plates of thermoplastic synthetic polymers and/or copolymers, said process comprises the stages of:

a) arranging an alveolar or cell plate on a table of a cutting device;

b) establishing reference points;

c) recognizing the positions of the reference points taking their location as correlation;

d) performing a plurality of carvings on the plate taking the reference points into account, where the carvings are defined by the design of the display to be manufactured, and wherein said carvings are executed according to the following steps selected from:
i) cutting completely through the plate;
ii) cutting partially on the surface avoiding piercing the plate completely;
iii) slitting V-shaped notches avoiding piercing the plate completely and the slit being in a parallel direction to the internal channels of the plate;
iv) slitting V-shaped notches avoiding piercing the plate completely and the slit being in a perpendicular direction to the internal channels of the plate;
v) slitting U-shaped fretworks avoiding piercing the plate completely;
vi) partially reduce the thickness of the plate to obtain U-shaped fretworks; and
vii) combinations of two or more of the above i) to vi);
where the cuts, slits and recesses allow separating portions, to fold by forming closed or open corners, insert portions without locking, insert portions by locking with swinging fins, and combinations thereof; and

e) assembling the display by folding, inserting and locking its constituent parts, where the cuts, slits and recesses executed according to the steps i) to vii) of the previous stage d) allow separating parts, to fold by forming closed or open corners, and insert parts without locking and insert parts by locking with swinging fins, so that a self-supporting structure of a display is obtained according to a predetermined design.

Additionally, prior to stage e) of assembling the display, a stage of packing, distributing and delivering the display as a flat carved plate at its installation or use site is performed. This facilitates the transport since the displays are unassembled, this is the carved plates according to a preset design are stacked, so they take up much less loading volume. Thus, with an equal loading volume, many more displays can be transported and distributed unassembled than assembled.

Similarly, another advantage of making the logistics of the unassembled displays is that, prior to stage e) of assembling the display by folding, inserting and locking its constituent parts, a film can be applied, having printed the main graphic design of the display. Thus, one main structural design of a particular display can be characterized in the installation site using different graphic designs that are applied at the time of its assembly.

Alternatively, prior to the additional stage of packing, distributing and delivering the display as a flat carved plate at its installation or use site, a film can be applied, having printed the main graphic design of the display. This characterization of the displays with particular designs plate by plate disassembled before being stacked in packages comprising a plurality of displays, allows an easy identification if deliveries are made to different display users for different uses in the same route.

Preferably, the film that is imprinted with a distinctive design for a given display is a self-adhesive vinyl.

In another alternative embodiment of the process according to the present invention, prior to stage a) arranging an alveolar or cell plate on a table of a cutting device, said process comprises additional stages of:

a′) printing a main graphic design of the display on a face of the alveolar or cell plate together with a plurality of registration marks that serve as a position register reference, wherein these registration marks are printed in any color different from the color of the substrate and on the face of the plate where the main graphic design of the display is located; and

a″) making through holes matching the printed registration marks in the previous step a′).

Since normally displays have imprinted information related to the product to be marketed, during the first step a) of the process of the present invention, accessorily a main graphic design of the display can be printed on the alveolar or cell plate thermoplastic synthetic polymer and/or copolymer together with a plurality of registration marks that serve as a guide to make the cuts, notches, fretworks and recesses that make the final shaping of the display at the time of assembly. All printing is preferably carried out on one side of the plate together with said registration marks.

Therefore, in step a′) of the process during which a plurality of registration marks that serve as a position register reference for the next stages of the process is printed, it is advantageous that such marks can be printed at the same time that the main graphic design of the display.

Consequently, stage a) of arranging the alveolar or cell plate on the table of the cutting device of this alternative process, consists of a′″) arranging the alveolar or cell plate on the table of the cutting device so that the face where the main design of the display and the registration marks were printed is facing down.

Similarly, after stage a) of arranging the alveolar or cell plate on the table of a cutting device with the printed side facing down, stages b) and c) respectively consist of:

b′) setting reference points based on the through holes of the registration marks; and

c′) recognizing the positions of the reference points based on the through holes of the registration marks taking their location as correlation.

In particular, the registration marks mentioned in step a′) are points, crosses, lines, circles, squares, or the like. In particular, it can be any identifiable geometric shape relative to the main design and essentially by a difference in color from the color of the plate material for easy and fast identification.

The following step a″) of the process proceeds to pierce the plate in those places with registration marks. The holes are through-going through the thickness of the plate and serve as references during steps b′) and c′) of the process.

The holes that are made in the step a″) can be performed by any manual, semiautomatic or automatic method. The important thing is that they are through-going and that they can be easily identified.

In this way, we can then proceed with the carving of the plate on the opposite side of the printed side with graphic design, taking into account the main structural pattern design of the displays.

Alveolar or cell plates used in the process according to the present invention are also known as plastic sheeting of corrugated material, plastic alveolar plates, plastic plates with pipes, corrugated plastic sheets (Coroplast or Corruplast), plastic cardboard, alveolar plastic plate, plastic plate with flutes, double-walled sheets joined by ribs (twin wall sheets or hollow plastic sheets), among others, and are multiwall-structure plates with good mechanical strength and low weight.

As materials constituting these plates usually thermoplastic polymers and/or copolymers are used, such as polyethylene, polypropylene and polyvinyl chloride.

Polyethylene (PE) is obtained by polymerizing ethylene, process in which molecules react to form a polymeric chain of repeating units of ethylene. The variation of polymerization reactions can produce different types of polyethylene with different properties. The main types of polyethylene are high density polyethylene (HDPE), low density polyethylene (LDPE), linear low-density polyethylene (LLDPE), medium density polyethylene (MDPE), and ultra high molecular weight polyethylene (PEUAMM). Also, ethylene by being polymerized with vinyl acetate generates an ethylene-vinyl acetate (EVA).

Polyvinyl chloride (PVC) is obtained from a series of chemical reactions combining ethylene and chlorine to form vinyl chloride, a monomer that generates PVC polymer chains when it polymerizes.

Polypropylene (PP) is a thermoplastic derived from propene. PP can be molded using heat as well as PE and PVC. There are three main types of PP homopolymers, random copolymers (random) and heterophasic copolymers.

Also, in the production stage of PE, PP and PVC generally various additives are added, which preserve their physicochemical characteristics and therefore their performance. Among the additives used, antioxidants, stabilizers, stabilizers to UV light, antistatic additives, flame retardants are highlighted, among others.

In particular, the alveolar or cell plates of polypropylene polymers and copolymers are preferred.

Preferably, the alveolar or cell plates are obtained by extruding the described polymers or copolymers, preferably polypropylene, providing a material of high impact resistance which is useful for printing rigid substrate. In cases where an impression on the plate is made, the same can be done either by screen printing and digital art by tracer (plotter) in a flatbed. It can also be coated with a printed film of self-adhesive vinyl or other sticky materials normally used in the graphic arts and advertising.

Alveolar or cell plates are durable, lightweight, waterproof, flexible, highly durable, inert, safe, hygienic, easy to cut and recyclable.

Stages a) to d) and the alternative stages a′″), b′) and c′) of the process according to the present invention can be carried out on the table of a cutting device by Computer Numerical Control (CNC), for example a device with ESKO KONGSBERG brand, model XP, comprising a flat table with a head with interchangeable tools such as: knife and/or laser, milling cutter and V-shaped cutting blade (V-Notch).

CNC is a system to control the position of a physical element at all times, typically a tool that is mounted on the cutting machine. This means that through a software and a command set the position coordinates of a point (the tool) are controlled with respect to an origin (0,0,0 of the machine).

In particular, a cutting device by CNC is a complex cutting machine that uses a large work area, at least one cutting element and an electronic component for computerized automated cutting techniques. The purpose of a cutting device by CNC is to cut different materials, particularly alveolar or cell plates of thermoplastic polymers or copolymers, in an automated fashion and with little operator intervention.

In step d) of the process a plurality of slits in the plate is performed, such as cuts, notches, fretworks and recesses which make the final shaping of the display (see FIG. 8) and are defined by the structural design of the display to be manufactured and whose main graphic design was printed in step a) on the alveolar or cell plate of polypropylene and/or polypropylene copolymers.

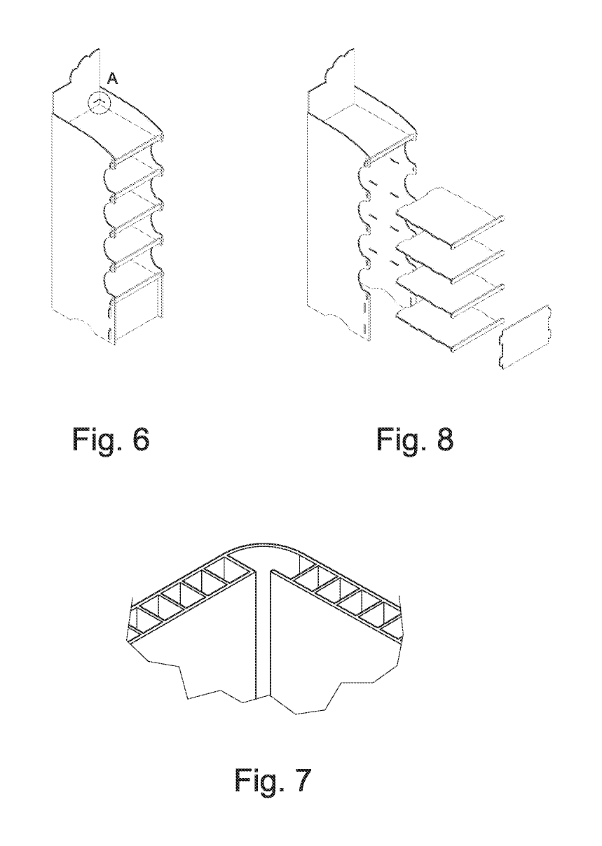

Particularly, in step d) i) cuts are performed by a blade or laser which define and allow separating the different parts of the display from the original plate. In particular, by said step d) i) cuts are performed the define and allow separating the different parts of the display from the plate (see FIG. 1). The obtained displays by the process of the present invention comprise a plurality of parts that are assembled to their final shaping. The parts that are independent are separated from the plate and then are inserted to form the display (see FIG. 6).

Also particularly, in step d) ii) cuts are performed by a knife or laser partially on the surface, avoiding piercing the plate completely to allow the display parts not to separate and to remain linked to each other so that they can function as a hinge during the display assembly.

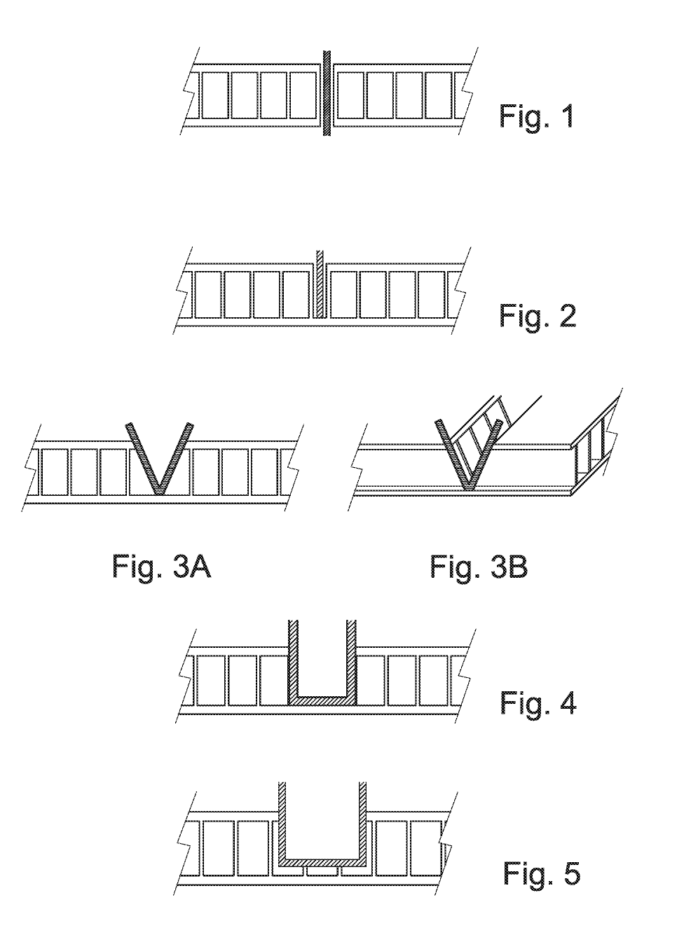

In this way, in step d) ii) cuts are performed on one surface of the plate, avoiding piercing the plate completely and affect the opposite surface, thus allowing that the parts of the plate affected by these cuts will not separate and to remain linked to each other so that they can fold during the display assembly (see FIG. 2).

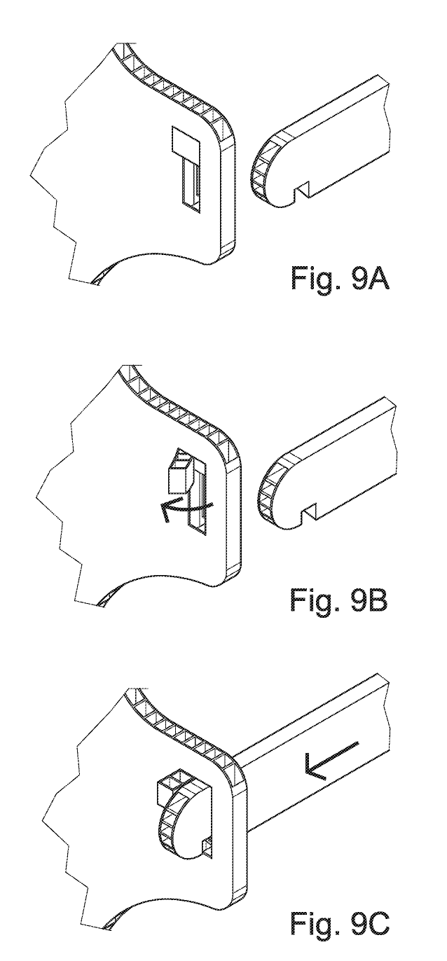

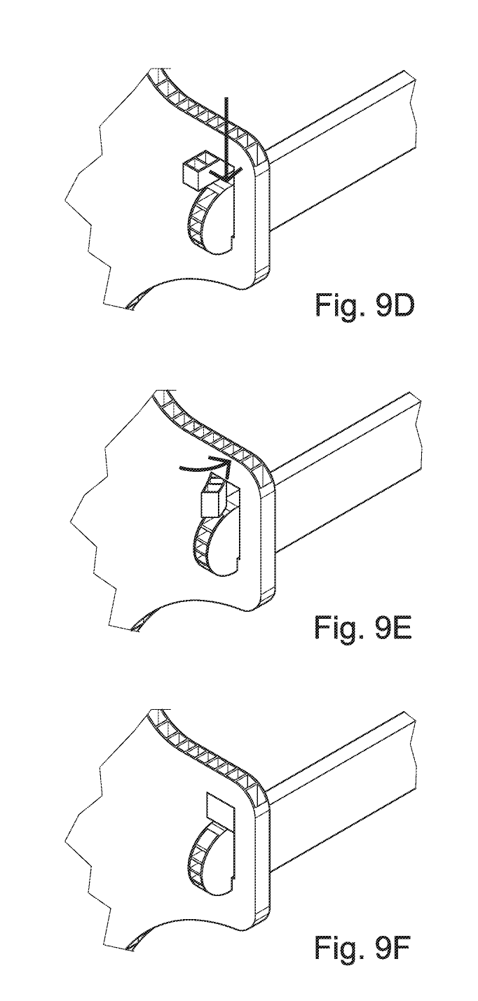

Only by combining step d) i) of cutting through the plate to generate a fretwork and step d) ii) of cutting partially on the surface of the plate to generate a plate portion as a hinge an insert can be obtained with linked insurance. This can be seen in the sequence of assembling steps of FIGS. 9 A to 9 F, wherein a portion of one of the parts that can be inserted together can pivot to allow the entry of another piece in the fretwork of the insert. Then, this portion pivots back to its original position officiating as a lock of the insert and preventing it from collapsing.

Also, in step d) iii) or step d) iv) V-shaped notches are performed by means of a blade with slanted edges at 45° to avoid cutting completely through the plate and allowing a folding of the plate by angular cutting during the display assembly.

Characteristically, by means of step d) iii) or step d) iv) V-shaped notches are performed, avoiding piercing the plate, this is leaving the surface of the opposite plate unaffected, and allowing a folding of the plate by angular cutting during the display assembly. To that purpose, see FIG. 3A illustrating a cut parallel to the internal channels of the plate and FIG. 3b illustrating a V-shaped cut perpendicular to the internal channels of the plate. Thus, some corners in closed angle or more reinforced corners are obtained by bending through a longitudinal notch disposed transversely according to the design of the display.

Step d) v) of slitting or step d) vi) of reducing the process according to the present invention are performed using a milling cutter and are done in order to generate folds areas.

Specially, in step d) v) U-shaped fretworks are performed by a milling cutter without piercing the plate, thus and allowing a folding of the plate by fretwork during the display assembly.

That is, by means of step d) v) U-shaped fretworks are performed just until the opposite surface, to avoid cutting completely through the plate, which allows a folding of the plate by fretwork during the display assembly (see FIG. 4). This fretwork helps to conform other type of corner as it provides a more comfortable and less closed fold than the one described above (see FIG. 7).

In step d) vi) U-shaped fretworks are performed by a milling cutter, said fretworks being partial recesses of the thickness of the plate, which allows generate a non-through insert.

By means of said step d) vi) U-shaped partial fretworks are performed of the thickness of the plate leaving intact the opposite surface to allow a non-through insert during the display assembly (see FIG. 5). This fretwork allows linking parts of the display that have no demand for a demanding mechanical stress.

Typically, the milling cutter used in step d) v) has approximately 6 mm in diameter, just like the milling cutter employed in step d) vi) and, in this particular step, by reduce is meant to effect two passes with a phase shift of approximately 3 mm between pass and pass.

In particular, step d) v) of slitting or step d) vi) of reducing using a milling cutter to generate folds areas or especially by step d) vi), inserts areas. In particular, a double pass as described above allows, for example, to generate a recess for a fin formed in a plate about 8 mm thick with a set of coupling of approximately 1 mm.

It is preferable that the different fretworks are made parallel to the internal channels of the plate, thus the folding of the plate offers less resistance and the face of the plate not affected acts as a hinge. Similarly, the longitudinally disposed fretwork allow that the weight of the display with display products to be transferred along the side of the display, by transferring weight to the floor through the septa.

However, for design conditions or due to limitations in the available area of the plate, the described millings can be performed transversely to the channels of the plate.

Normally, during the process of the present invention to produce various displays various cuts, slits and recesses are performed, according to various combinations of steps i) to vii) of stage d), which subsequently allows, during the assembly, to separate the parts, to fold by forming closed or open corners, to insert parts without locking and to insert parts by locking swinging fins, so that self-supporting structures of displays can be obtained according to a predetermined design.

1. A process to produce displays from alveolar or cell plates of thermoplastic synthetic polymers and/or copolymers, said process comprising the stages of:
a) arranging an alveolar or cell plate on a table of a cutting device;
b) establishing reference points;
c) recognizing the positions of the reference points taking their location as correlation;
d) performing a plurality of carvings on the plate taking the reference points into account, where the carvings are defined by the design of the display to be manufactured, and wherein said carvings are executed according to the following steps selected from:
i) cutting completely through the plate;
ii) cutting partially on the surface avoiding piercing the plate completely;
iii) slitting V-shaped notches avoiding piercing the plate completely and the slit being in a parallel direction to the internal channels of the plate;
iv) slitting V-shaped notches avoiding piercing the plate completely and the slit being in a perpendicular direction to the internal channels of the plate;
v) slitting U-shaped fretworks avoiding piercing the plate completely;
vi) partially reduce the thickness of the plate to obtain U-shaped fretworks; and
vii) combinations of two or more of the above i) to vi);
where the cuts, slits and recesses allow separating portions, to fold by forming closed or open corners, insert portions without locking, insert portions by locking with swinging fins, and combinations thereof; and
e) assembling the display by folding, inserting and locking its constituent parts, where the cuts, slits and recesses executed according to the steps i) to vii) of the previous stage d) allow separating parts, to fold by forming closed or open corners, and insert parts without locking and insert parts by locking with swinging fins, so that a self-supporting structure of a display is obtained according to a predetermined design.

2. Process according to claim 1, wherein additionally prior to stage e) of assembling the display, a stage of packing, distributing and delivering the display as a flat carved plate at its installation or use site is performed.

3. Process according to claim 1, wherein prior to stage e) of assembling the display by folding, inserting and locking its constituent parts, a film having printed the main graphic design of the display is applied.

4. Process according to claim 2, wherein prior to the additional stage of packing, distributing and delivering the display as a flat carved plate at its installation or use site a film having printed the main graphic design of the display is applied.

5. Process according to claim 3, wherein the film is a self-adhesive vinyl.

6. Process according to claim 1, wherein prior to stage a) of arranging an alveolar or cell plate on a table of a cutting device, it comprises additional stages of:
a′) printing a main graphic design of the display on a face of the alveolar or cell plate together with a plurality of registration marks that serve as a position register reference, wherein these registration marks are printed in any color different from the color of the substrate and on the face of the plate where the main graphic design of the display is located; and
a″) making through holes matching the printed registration marks in the previous step a′).

7. Process according to claim 6, wherein the stage a) of arranging the alveolar or cell plate on the table of the cutting device, consists of a′″) arranging the alveolar or cell plate on the table of the cutting device so that the face where the main design of the display and the registration marks were printed is facing down.

8. Process according to claim 7, wherein after step a) of arranging the alveolar or cell plate on the table of a cutting device with the printed side facing down, stages b) and c) respectively consist of:
b′) setting reference points based on the through holes of the registration marks; and
c′) recognizing the positions of the reference points based on the through holes of the registration marks taking their location as correlation.

9. Process according to claim 6, wherein the registration marks of stage a′) are points, crosses, lines, circles, squares, or the like.

10. Process according to claim 6, wherein the through holes of step a″) are performed by any manual, semiautomatic or automatic method.

11. Process according to claim 1, wherein the constituent materials of the alveolar or cell plates are thermoplastic synthetic polymers and/or copolymers selected from polyethylene, polypropylene and polyvinyl chloride.

12. Process according to claim 1, wherein the cutting device is a cutting device by Computer Numerical Control (CNC) comprising: a flat table with a head with interchangeable tools that are selected from cutter, laser, milling cutter, V-shaped cutting blade (V-Notch) and combinations thereof.

13. Process according to claim 1, wherein cuts are performed in step d) i) by a blade or laser, which define and allow separating the different parts of the plate display.

14. Process according to claim 1, wherein cuts are performed in step d) ii) by a blade or laser partially on the surface avoiding piercing the plate completely, allowing the display parts not to separate and to remain linked to each other so that they can function as a hinge during the display assembly.

15. Process according to claim 1, wherein combining step d) i) of cutting completely through the plate to generate a fretwork and step d) ii) of cutting partially on the surface of the plate to generate a plate portion as a hinge, an insert with linked insurance is obtained.

16. Process according to claim 1, wherein V-shaped notches are performed in step d) iii) or step d) iv) by means of a blade with slanted edges at 45° to avoid cutting completely through the plate and allowing a folding of the plate by angular cutting during the display assembly.

17. Process according to claim 1, wherein U-shaped fretworks are performed in step d) v) by a milling cutter to avoid cutting completely through the plate and allowing a folding of the plate by fretwork during the display assembly.

18. Process according to claim 1, wherein U-shaped fretworks are performed in step d) vi) by a milling cutter, said fretworks being partial recesses of the thickness of the plate to allow a non-through insert during the display assembly.

19. Process according to claim 1, wherein step d) v) of slitting or step d) vi) of reducing using a milling cutter to generate folds areas.
